(19) United States
(12) Patent Application Publication
(10) Pub. No.: US 2026/0030718 A1
(43) Pub. Date: Jan. 29, 2026

(54) IMAGE PROCESSING DEVICE AND OPERATION METHOD THEREFOR

(71) Applicant: SAMSUNG ELECTRONICS CO., LTD., Suwon-si (KR)

(72) Inventors: Incheon CHO, Suwon-si (KR); Soomin KANG, Suwon-si (KR)

(73) Assignee: SAMSUNG ELECTRONICS CO., LTD., Suwon-si (KR)

(21) Appl. No.: 19/348,284

(22) Filed: Oct. 2, 2025

(30) Foreign Application Priority Data
Apr. 5, 2023 (KR) 10-2023-0045037
Aug. 17, 2023 (KR) 10-2023-0107856

(51) Int. Cl. G06T 3/18; G06T 3/4046; G06T 7/73

(52) U.S. Cl. CPC G06T 3/18; G06T 3/4046; G06T 7/73; G06T 2207/20084

(57) ABSTRACT

Provided is a method of processing an image including obtaining an image feature from an input image, obtaining a first warped feature from the image feature, obtaining, by using coordinate information, a second warped feature from the input image, and generating a warped image by using the first warped feature and the second warped feature. The obtaining the first warped feature from the image feature includes obtaining, from the image feature, a high-frequency feature corresponding to a high-frequency region of the input image, transforming the high-frequency feature into a B-spline representation, and generating the first warped feature based on the image feature and the B-spline representation.

### CROSS-REFERENCE TO RELATED APPLICATIONS

This application is a continuation of International Application No. PCT/KR2024/002812 designating the United States, filed on Mar. 5, 2024, in the Korean Intellectual Property Receiving Office and claiming priority to Korean Patent Application No. 10-2023-0045037, filed on Apr. 5, 2023, in the Korean Intellectual Property Office, and Korean Patent Application No. 10-2023-0107856, filed on Aug. 17, 2023, in the Korean Intellectual Property Office, the disclosures of each of which are incorporated by reference herein in their entireties.

### BACKGROUND

### 1. Field

The present disclosure relates to an image processing apparatus and an operating method thereof.

### 2. Description of Related Art

Image warping is a technology for reconstructing an image to have an arbitrary shape for geometric transformation (e.g., similarity transformation, Euclidean transformation, affine transformation, or projective transformation) of the image.

For example, image warping may be used in a super-resolution image transformation technology for transforming a low-quality image into a high-quality image, a document scanning technology using a mobile device (e.g., a smartphone, a tablet, or the like) including a camera, or a correction technology for preventing image distortion during projection of an image onto an angled surface or a curved surface by using a beam projector.

During an image warping process, some areas of an image may be upscaled while other areas of the image may be downscaled. In this case, various artifacts may occur in a warped image, such as blur in the upscaled areas and jagging or moire in the downscaled areas.

To solve these problems, methods of transforming discrete information into continuous information have been attempted. For example, there is a method of performing image warping by approximating features, which have passed through an artificial neural network, into a continuous domain through a Fourier transform. However, because a plurality of sine and cosine functions are applied to all features for the Fourier transform, there are problems in that a high computational cost is required, and overshoot or undershoot may occur during transformation from a discrete space into a continuous space.

### SUMMARY

According to an aspect of the disclosure, there is provided a method of processing an image, the method including: obtaining an image feature from an input image; obtaining a first warped feature from the image feature; obtaining, by using coordinate information, a second warped feature from the input image; and generating a warped image by using the first warped feature and the second warped feature, wherein the obtaining the first warped feature from the image feature includes: obtaining, from the image feature, a high-frequency feature corresponding to a high-frequency region of the input image; transforming the high-frequency feature into a B-spline representation; and generating the first warped feature based on the image feature and the B-spline representation.

The obtaining the image feature from the input image may include obtaining the image feature at a plurality of levels.

The obtaining the high-frequency feature corresponding to the high-frequency region of the input image from the image feature may include: obtaining a discrete cosine transform (DCT) coefficient by performing a DCT on the image feature; removing, from the DCT coefficient, components corresponding to low frequencies; and generating the high-frequency feature by performing an inverse DCT on the DCT coefficient from which the components corresponding to the low frequencies are removed.

The transforming the high-frequency feature into the B-spline representation may include: obtaining from the high-frequency feature, by using a first convolutional neural network, a first feature associated with a feature value identified based on a B-spline basis; obtaining from the high-frequency feature, by using a second convolutional neural network, a second feature associated with a slope of the B-spline basis; obtaining from the high-frequency feature, by using a third convolutional neural network, a third feature associated with a bias of the B-spline basis; and generating the B-spline representation based on the first feature, the second feature, and the third feature.

The generating the B-spline representation based on the first feature, the second feature, and the third feature may include: generating one or more B-spline bases based on the second feature, the third feature, and relative coordinate information representing a position of a target pixel; based on the one or more B-spline bases, identifying a basis weight corresponding to the target pixel; and generating the B-spline representation by performing a weighted sum operation between the first feature and the basis weight.

The generating the first warped feature based on the image feature and the B-spline representation may include: processing the image feature and downscaled coordinate information by using a bilinear warping module; processing the B-spline representation by using a multilayer perceptron (MLP) network; and generating the first warped feature by performing elementwise addition of an output of the MLP network and an output of the bilinear warping module.

The generating the warped image by using the first warped feature and the second warped feature may include: generating, by decoding the first warped feature, a sub-feature configured to reconstruct the warped image; and concatenating the sub-feature with the second warped feature and generating the warped image by using a convolutional neural network.

The method may include receiving a user input for determining the coordinate information.

The method may include: detecting a distance between a screen onto which the warped image is to be projected and an image processing apparatus and a shape of the screen onto which the warped image is to be projected; and determining the coordinate information based on the detected distance and the detected shape.

According to an aspect of the disclosure, there is provided a non-transitory computer-readable recording medium having stored thereon instructions that are executed by at least one processor individually or collectively to perform a method including: obtaining an image feature from an input image; obtaining a first warped feature from the image feature; obtaining, by using coordinate information, a second warped feature from the input image; and generating a warped image by using the first warped feature and the second warped feature, wherein the obtaining the first warped feature from the image feature includes: obtaining, from the image feature, a high-frequency feature corresponding to a high-frequency region of the input image; transforming the high-frequency feature into a B-spline representation; and generating the first warped feature based on the image feature and the B-spline representation.

According to an aspect of the disclosure, there is provided an electronic apparatus for processing an image, the electronic apparatus including: memory storing instructions for processing the image; and at least one processor, wherein the instructions, when executed by the at least one processor individually or collectively, cause the electronic apparatus to: obtain an image feature from an input image; obtain a first warped feature from the image feature; obtain, by using coordinate information, a second warped feature from the input image; and generate a warped image by using the first warped feature and the second warped feature, wherein the instructions, when executed by the at least one processor individually or collectively, cause the electronic apparatus to obtain the first warped feature from the image feature by: obtaining, from the image feature, a high-frequency feature corresponding to a high-frequency region of the input image; transforming the high-frequency feature into a B-spline representation; and generating the first warped feature based on the image feature and the B-spline representation.

The instructions, when executed by the at least one processor individually or collectively, may cause the electronic apparatus to transform the transforming the high-frequency feature into the B-spline representation by obtaining from the high-frequency feature, by using a first convolutional neural network, a first feature associated with a feature value identified based on a B-spline basis; obtaining from the high-frequency feature, by using a second convolutional neural network, a second feature associated with a slope of the B-spline basis; obtaining from the high-frequency feature, by using a third convolutional neural network, a third feature associated with a bias of the B-spline basis; and generating the B-spline representation based on the first feature, the second feature, and the third feature.

The instructions, when executed by the at least one processor individually or collectively, may cause the electronic apparatus to generate the B-spline representation based on the first feature, the second feature, and the third feature by: generating one or more B-spline bases based on the second feature, the third feature, and relative coordinate information representing a position of a target pixel; based on the one or more B-spline bases, identifying a basis weight corresponding to the target pixel; and generating the B-spline representation by performing a weighted sum operation between the first feature and the basis weight.

The instructions, when executed by the at least one processor individually or collectively, may cause the electronic apparatus to generate the first warped feature based on the image feature and the B-spline representation by: processing the image feature and downscaled coordinate information by using a bilinear warping module; processing the B-spline representation by using a multilayer perceptron (MLP) network; and generating the first warped feature by performing elementwise addition of an output of the MLP network and an output of the bilinear warping module.

The instructions, when executed by the at least one processor individually or collectively, may cause the electronic apparatus to generate the warped image by using the first warped feature and the second warped feature by: generating, by decoding the first warped feature, a sub-feature configured to reconstruct the warped image; and concatenating the sub-feature with the second warped feature and generating the warped image by using a convolutional neural network.

### BRIEF DESCRIPTION OF THE DRAWINGS

The above and other aspects and/or features of embodiments of the disclosure will become more apparent from the following detailed description taken in conjunction with the accompanying drawings, in which:

FIG. 1 illustrates an image processing system according to an embodiment of the present disclosure;

FIG. 2 is a diagram illustrating a structure and operation of an image feature extraction module, according to an embodiment of the present disclosure;

FIG. 3 is a diagram illustrating a structure and operation of a B-spline warping module, according to an embodiment of the present disclosure;

FIG. 4 is a diagram illustrating an operation of a high-frequency feature extraction module, according to an embodiment of the present disclosure;

FIG. 5 is a diagram illustrating an operation of a B-spline representation module, according to an embodiment of the present disclosure;

FIG. 6 is a diagram illustrating a structure and operation of an image reconstruction module, according to an embodiment of the present disclosure;

FIG. 7A is a flowchart of a method of processing an image, according to an embodiment of the present disclosure;

FIG. 7B is a flowchart of a method of processing an image, according to an embodiment of the present disclosure;

FIG. 8 is a block diagram of an image processing apparatus according to an embodiment of the present disclosure;

FIG. 9 illustrates an example in which an image processing system is applied to a mobile apparatus, according to an embodiment of the present disclosure; and

FIG. 10 illustrates an example in which an image processing system is applied to a projector, according to an embodiment of the present disclosure.

### DETAILED DESCRIPTION

Throughout the present disclosure, the expression “at least one of a, b or c” indicates “a”, “b”, “c”, “a and b”, “a and c”, “b and c”, or “a, b, and c.”.

All terms used in the present disclosure are those general terms currently widely used in the art in consideration of functions in regard to embodiments, but the terms may vary according to the intention of those of ordinary skill in the art, precedents, or new technologies in the art. Furthermore, some particular terms may be arbitrarily selected by the applicant, and in this case, the meaning of the selected terms will be described in detail in the detailed description of the disclosure. Thus, the terms used in the present disclosure should be understood not as simple names but based on the meaning of the terms and the overall description of the present disclosure.

The terms first, second, etc. may be used to describe various components, but the components should not be limited by these terms. The terms are used only to distinguish one component from another component. For example, without departing from the scope of the one or more embodiments, a first component may be referred to as a second component, and similarly, a second component may also be referred to as a first component.

It should be understood that when a component is referred to as being “connected” or “joined” to another component, the component may not only be directly connected or joined to the other component, but the components may also be connected or joined via another intervening component therebetween. In contrast, it should be understood that when a component is referred to as being “directly connected” or “directly joined” to another component, there is no intervening component therebetween.

It is to be understood that the singular forms, “a”, “an”, and “the”, include the plural forms as well, unless the context clearly indicates otherwise. Thus, for example, the term “a component surface” may also include one or more of such surfaces.

The singular forms “a”, “an”, and “the” may be intended to include the plural forms as well, unless the context clearly indicates otherwise. The terms used herein including technical or scientific terms may have the same meaning as commonly understood by one of ordinary skill in the art described herein.

Throughout the present disclosure, it should be understood that the terms “include”, “comprise”, or “have” are intended to indicate the presence of features, numbers, steps, operations, components, parts, or combinations thereof described in the present disclosure, and do not preclude the presence or addition of one or more other features, numbers, steps, operations, components, parts, or combinations thereof.

In the present disclosure, two or more components expressed as “ . . . ors/ers”, “units”, or “modules” may be combined into one component, or one component may be divided into two or more components with more detailed functions. In addition, each component described below may additionally perform, in addition to its own main function, some or all of the functions performed by other components, and some of the main functions performed by each component may be performed exclusively by other components.

Any function or operation described in the present disclosure may be performed by a single processor or a combination of processors. The single processor or the combination of processors may include circuitry that performs processing, such as an application processor (AP), a communication processor (CP), a graphics processing unit (GPU), a neural processing unit (NPU), a microprocessor unit (MPU), a system-on-chip (SoC), or an integrated chip (IC).

In the present disclosure, functions related to artificial intelligence may be performed through a processor and a memory. The processor may include one or more processors. In this case, the one or more processors may include a general-purpose processor such as a central processing unit (CPU), an AP, or a digital signal processor (DSP), a graphics-dedicated processor such as a GPU or a vision processor (VPU), or an artificial intelligence-dedicated processor such as an NPU. The one or more processors may process input data according to predefined operating rules or artificial intelligence models stored in a memory. Alternatively, when the one or more processors include an artificial intelligence-dedicated processor, the artificial intelligence-dedicated processor may be designed in a hardware structure specialized for processing of a specific artificial intelligence model.

The predefined operating rules or artificial intelligence models are created through training. In this regard, creating the predefined operating rules or artificial intelligence models through training may mean that basic artificial intelligence models are trained by using a plurality of training data by a learning algorithm such that predefined operation rules or artificial intelligence models set to perform desired characteristics (or purposes) are created. Such training may be performed in a device on which artificial intelligence according to the present disclosure is performed, or may be performed through a separate server and/or system. Examples of the learning algorithm include supervised learning, unsupervised learning, semi-supervised learning, or reinforcement learning, but are not limited to the aforementioned examples.

The artificial intelligence model may include a plurality of neural network layers. Each of the plurality of neural network layers has a plurality of weight values, and may perform a neural network operation by using an operation result of a previous layer and an operation between the plurality of weight values. The plurality of weights of the plurality of neural network layers may be optimized based on training results of the artificial intelligence models. For example, the plurality of weights may be updated to reduce or minimize a loss value or a cost value obtained from the artificial intelligence model during a training process. An artificial neural network may include a deep neural network (DNN), for example, a convolutional neural network (CNN), a DNN, a recurrent neural network (RNN), a restricted Boltzmann machine (RBM), a deep belief network (DBM), a bidirectional recurrent deep neural network (BRDNN), deep Q-networks, and the like, but is not limited to the aforementioned examples.

In the present disclosure, a machine-readable storage medium may be provided in a form of a non-transitory storage medium. In this regard, the “non-transitory storage medium” simply means that the storage medium is a tangible apparatus and does not include a signal (e.g., an electromagnetic wave), but this term does not differentiate between where data is semi-permanently stored in the storage medium and where the data is temporarily stored in the storage medium. For example, the “non-transitory storage medium” may include a buffer in which data is temporarily stored.

In the present disclosure, it should be understood that blocks in each flowchart and combinations of flowcharts may be performed by one or more computer programs including computer-executable instructions. The one or more computer programs may all be stored in a single memory or may be divided and stored in different memories.

According to an embodiment, the method according to various embodiments provided in the present disclosure may be provided by being included in a computer program product. The computer program product may be traded as a product between a seller and a buyer. The computer program product may be distributed in a form of a machine-readable storage medium (e.g., a compact disc read-only memory (CD-ROM)), or distributed (e.g., downloaded or uploaded) through an application store, or directly or online between two user apparatuses (e.g., smartphones). In the case of online distribution, at least a portion of the computer program product (e.g., a downloadable application) may be temporarily stored in a machine-readable storage medium, such as a memory of a manufacturer's server, an application store's server, or a relay server, or may be temporarily generated.

Hereinafter, one or more embodiments of the present disclosure will be described in detail with reference to the accompanying drawings such that one of ordinary skill in the art may easily implement the one or more embodiments. The present disclosure may, however, be embodied in many different forms and should not be construed as limited to the one or more embodiments set forth herein.

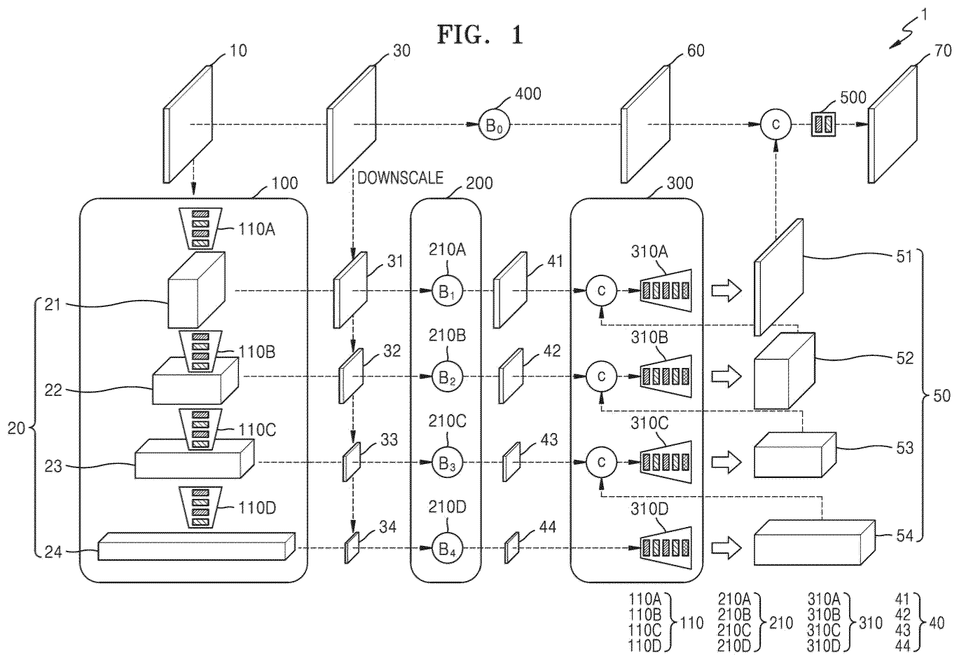

FIG. 1 illustrates an image processing system 1 according to an embodiment of the present disclosure.

According to an embodiment of the present disclosure, the image processing system 1 may generate a warped image 70 by performing image warping on an input image 10 by using an artificial neural network. In the present disclosure, an image may include static visual data such as a photograph, and dynamic visual data such as a video. Accordingly, it may be understood that, when the input image 10 is a photograph, operations of the image processing system 1 described below are performed on the photograph, and it may be understood that, when the input image 10 is a video, the operations of the image processing system 1 are performed on each frame constituting the video.

Image warping is a technology for reconstructing an image to have an arbitrary shape for geometric transformation (e.g., similarity transformation, Euclidean transformation, affine transformation, or projective transformation) of the image. In the present disclosure, the shape of the image may include not only the shape (e.g., a rectangular shape) of the image but also the size (e.g., resolution) of the image.

As an example, when a projector projects an image onto an angled surface or a curved surface, image warping may be used to transform the shape of an original image such that the projected image is not distorted when viewed by a user. As another example, even when a document is scanned by using a mobile device (e.g., a smartphone, a tablet, or the like), image warping may be used to transform an obliquely captured document image having a parallelogram shape into a rectangular image. Also, as another example, image warping may be used in a super-resolution image transformation technology for transforming a low-resolution (e.g., 1920×1080) image into a high-resolution (e.g., 3840×2160) image.

In an embodiment, an image feature extraction module 100 may extract an image feature 20 from the input image 10. The image feature extraction module 100 may include one or more encoders 100 including one or more convolutional layers and one or more activation functions. For example, the activation functions may include sigmoid, rectified linear unit (ReLU), leaky ReLU, Tanh, or the like, but are not limited thereto.

In an embodiment, the image feature extraction module 100 may hierarchically extract the image feature 20. In this case, the image feature extraction module 100 may include a plurality of encoders 110. Each of the encoders 110 may extract a high-level image feature from a low-level image feature extracted from a previous encoder. In this case, it may be understood that the high-level image feature corresponds to coarse information about the input image 10, and it may be understood that the low-level image feature corresponds to fine information about the input image 10. The coarse information may correspond to a relatively large object or a relatively large-area portion within an image, and the fine information may correspond to a relatively small object or a relatively detailed portion of an object within an image. For example, when the image depicts a city landscape with high-rise buildings, the coarse information may correspond to the outlines (or boundaries) of the high-rise buildings, and the fine information may correspond to windows of the high-rise buildings.

For example, as shown in FIG. 1, when the image feature extraction module 100 extracts image features in four levels (i.e., hierarchies), a first encoder 110A may extract a first image feature 21 from the input image 10, a second encoder 110B may extract a second image feature 22 from the first image feature 21, a third encoder 110C may extract a third image feature 23 from the second image feature 22, and a fourth encoder 110D may extract a fourth image feature 24 from the third image feature 23. In this case, the first image feature 21 corresponds to the lowest-level image feature, and the fourth image feature 24 corresponds to the highest-level image feature. However, although FIG. 1 illustrates a case where the image feature extraction module 100 extracts image features in four levels, this is only an example and the number of levels (i.e., hierarchies) is not limited thereto.

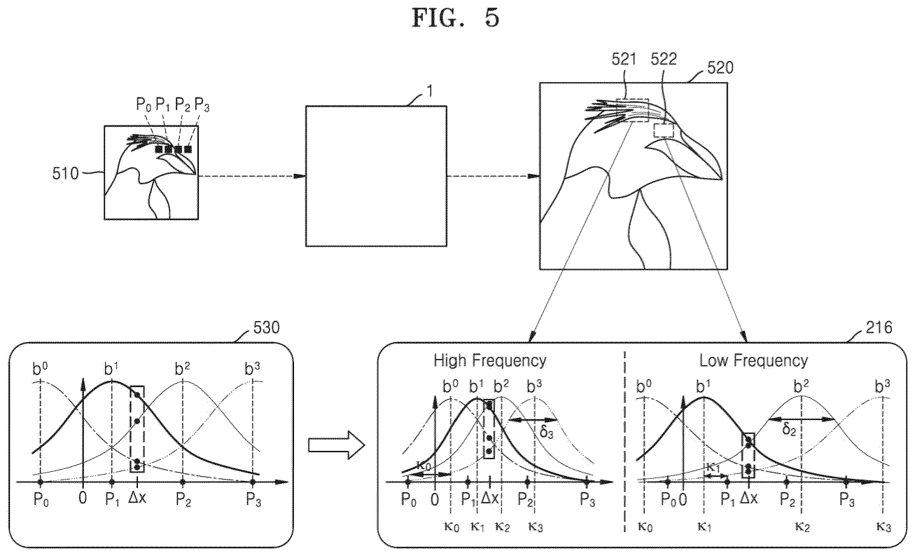

In an embodiment, a first warping module 200 may extract a first warped feature 40 from the image feature 20. The first warping module 200 may extract a high-frequency feature corresponding to a high-frequency region of the input image 10 from the image feature 20 by using pieces of downscaled coordinate information 31, 32, 33, and 34, transform the high-frequency feature into a B-spline representation, and generate the first warped feature 40 based on the image feature 20 and the B-spline representation. In this case, the pieces of downscaled coordinate information 31, 32, 33, and 34 may be obtained by downscaling coordinate information 30 in stages. Each of the pieces of downscaled coordinate information 31, 32, 33, and 34 may have the same dimension as first to fourth image features 21, 22, 23, and 24. In the present disclosure, it may be understood that the high-frequency region of the input image 10 is a region where the difference in pixel value (e.g., intensity, red-green-blue (RGB) value, or the like) from surrounding pixels is large, and it may be understood that a low-frequency region of the input image 10 is a region where the difference in pixel value from the surrounding pixels is small. For example, because a high-frequency region 521 illustrated in FIG. 5 includes both a bird's facial portion and feathers on the bird's head, pixels in the high-frequency region 521 have a large difference in pixel value from the surrounding pixels, and most pixels of a low-frequency region 522 have the same color and thus have a small difference in pixel value from the surrounding pixels.

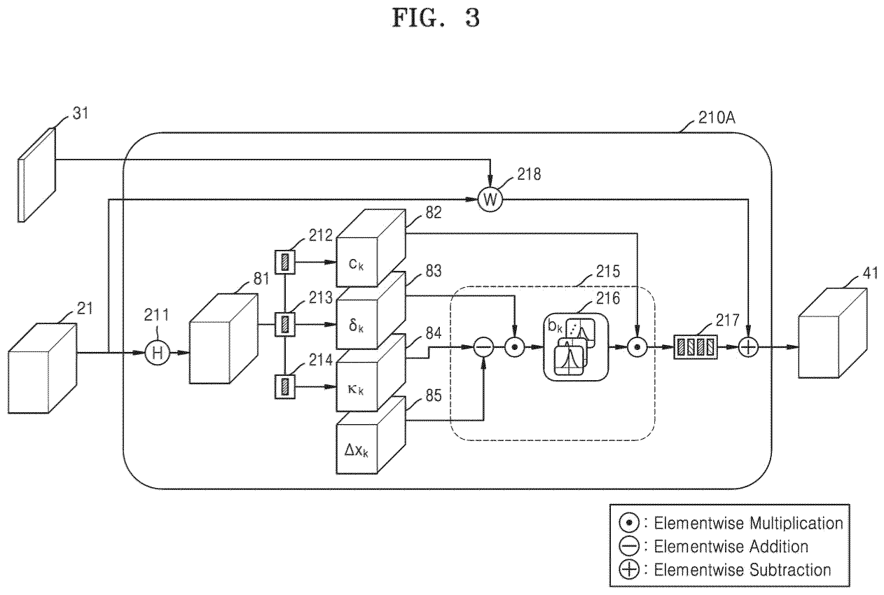

In an embodiment, the first warping module 200 may include one or more B-spline warping modules 210. For example, when the image feature extraction module 100 includes one encoder 110 and extracts one image feature, the first warping module 200 may include one B-spline warping module 210. In contrast, when the image feature extraction module 100 includes the plurality of encoders 110 and hierarchically extracts image features, the first warping module 200 may include a plurality of B-spline warping modules 210A, 210B, 210C, and 210D. The structure and operation of the B-spline warping modules 210 are described below with reference to FIGS. 3 to 5.

In an embodiment, an image reconstruction module 300 generates a sub-feature 50 configured to reconstruct the warped image 70, by decoding the first warped feature 40. The image reconstruction module 300 may include one or more decoders 310 including a convolutional layer, a deconvolutional layer, and an activation function. For example, the activation functions may include sigmoid, ReLU, leaky ReLU, Tanh, or the like, but are not limited thereto.

In an embodiment, the image reconstruction module 300 may hierarchically decode the first warped feature 40. In this case, the image reconstruction module 300 may include a plurality of decoders 310. Each of the decoders 310 may generate a low-level sub-feature by concatenating a sub-feature decoded by a high-level decoder with a warped feature of a current level and decoding the concatenated features.

For example, as shown in FIG. 1, a fourth decoder 310D may generate a fourth sub-feature 54 by decoding a first warped feature 44, a third decoder 310C may generate a third sub-feature 53 by concatenating the fourth sub-feature 54 with a first warped feature 43 and decoding the concatenated features, a second decoder 310B may generate a second sub-feature 52 by concatenating the third sub-feature 53 with a first warped feature 42 and decoding the concatenated features, and a first decoder 310A may generate a first sub-feature 51 by concatenating the second sub-feature 52 with a first warped feature 41 and decoding the concatenated features.

As described above, the image processing system 1 according to an embodiment of the present disclosure may be implemented with a coarse-to-fine structure of extracting the image feature 20 from the input image 10 in a plurality of levels (i.e., hierarchically), warping image features of respective levels, and then hierarchically restoring the results again, thereby achieving improved image restoration performance by sequentially restoring information corresponding to the high-frequency region of the input image 10. Also, the image processing system 1 according to an embodiment of the present disclosure may obtain a robust restored image from an artifact, such as blur, jagging, or moire, that is likely to occur in a high-frequency region of an image.

In an embodiment, a second warping module 400 may transform the input image 10 into a B-spline representation by using the coordinate information 30 and generate a second warped feature 60 for the input image 10 based on the B-spline representation. The structure and operation of the second warping module 400 are the same as the B-spline warping module 210. In this case, the coordinate information 30 is coordinate information about the warped image 70 determined through a transformation operation based on input coordinate information that is normalized (e.g., to a value between −1 and 1 in each of width and height directions) for the input image 10, wherein the transformation operation may vary based on the shape of the input image 10 and the shape of the warped image 70. As an example, the coordinate information 30 may be determined in advance based on the purpose (e.g., super-resolution image transformation for reconstructing an image of a first resolution into an image of a second resolution) for which the image processing system 1 is applied. As another example, the coordinate information 30 may be input from a user. Also, as another example, the coordinate information 30 may be determined based on the shape of a screen onto which a warped image is to be projected.

In an embodiment, the image processing system 1 may generate the warped image 70 by using the sub-feature 50 and the second warped feature 60. For example, as shown in FIG. 1, the image processing system 1 may concatenate the first sub-feature 51, which is a result of decoding the first warped feature 41, with the second warped feature 60 and generate the warped image 70 by using a convolutional neural network 500. For example, the convolutional neural network 500 may include a convolutional layer and an activation function.

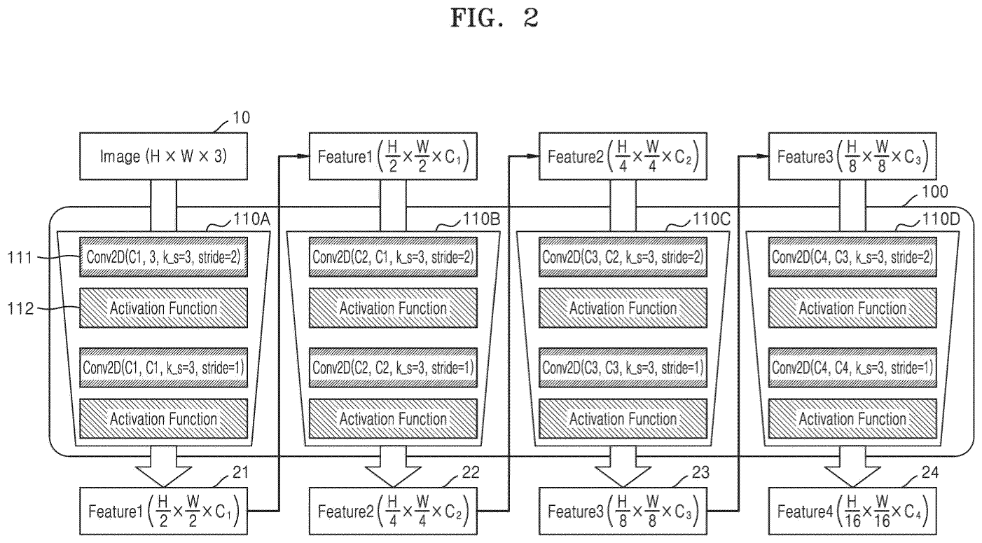

FIG. 2 is a diagram illustrating a structure and operation of the image feature extraction module 100, according to an embodiment of the present disclosure. The image feature extraction module 100 illustrated in FIG. 2 corresponds to a case where image features are extracted in four levels, but the number of levels (i.e., hierarchies) is not limited thereto as described above.

In an embodiment, the image feature extraction module 100 may hierarchically extract the image feature 20. In this case, the image feature extraction module 100 may include the plurality of encoders 110. Each of the encoders 110 may include two consecutive convolutional layers 111 and activation functions 112.

The first encoder 110A may extract the first image feature 21 from the input image 10. In this case, the first encoder 110A may extract the first image feature 21 having a set number (C₁) of channels by reducing the height and width of the input image 10 by half. For example, when the input image 10 is represented as a vector of (H×W×3) dimensions, the first image feature 21 may be represented as a vector of (H/2×W/2×C₁) dimensions.

The second encoder 110B may extract the second image feature 22 from the first image feature 21. In this case, the second encoder 110B may extract the second image feature 22 having a set number (C₂) of channels by reducing the height and width of the first image feature 21 by half. For example, when the input image 10 is represented as a vector of (H×W×3) dimensions, the second image feature 22 may be represented as a vector of (H/4×W/4×C₂) dimensions.

The third encoder 110C may extract the third image feature 23 from the second image feature 22. In this case, the third encoder 110C may extract the third image feature 23 having a set number (C₃) of channels by reducing the height and width of the second image feature 22 by half. For example, when the input image 10 is represented as a vector of (H×W×3) dimensions, the third image feature 23 may be represented as a vector of (H/8×W/8×C₃) dimensions.

The fourth encoder 110D may extract the fourth image feature 24 from the third image feature 23. In this case, the fourth encoder 110D may extract the fourth image feature 24 having a set number (C₄) of channels by reducing the height and width of the third image feature 23 by half. For example, when the input image 10 is represented as a vector of (H×W×3) dimensions, the fourth image feature 24 may be represented as a vector of (H/16×W/16×C₄) dimensions.

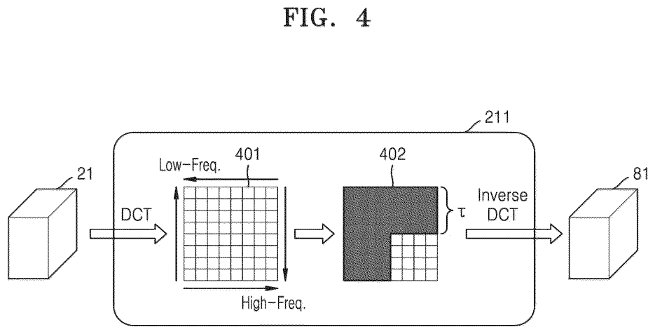

FIG. 3 is a diagram illustrating a structure and operation of a B-spline warping module 210A, according to an embodiment of the present disclosure, FIG. 4 is a diagram illustrating an operation of a high-frequency feature extraction module 211, according to an embodiment of the present disclosure, and FIG. 5 is a diagram illustrating the operation of a basis weight calculation module 216 according to an embodiment of the present disclosure.

In an embodiment, the B-spline warping module 210A may include the high-frequency feature extraction module 211, a first convolutional neural network 212, a second convolutional neural network 213, a third convolutional neural network 214, a B-spline representation module 215, a multilayer perceptron (MLP) network 217, and a bilinear warping module 218.

In an embodiment, the high-frequency feature extraction module 211 may extract, from an image feature 21, a high-frequency feature 81 corresponding to a high-frequency region of an input image. For example, the high-frequency feature extraction module 211 may extract a high-frequency feature by using a discrete cosine transform (DCT) or a Gaussian blur kernel.

As shown in FIG. 4, when the high-frequency feature extraction module 211 extracts a high-frequency feature by using a DCT, the high-frequency feature extraction module 211 may extract DCT coefficients 401 by performing a DCT on the image feature 21, remove, from the DCT coefficient 401, components corresponding to low frequencies, and generate a high-frequency feature 81 by performing an inverse DCT on a DCT coefficient 402 from which the components corresponding to the low frequencies are removed. In this case, the DCT coefficient 402 may be a matrix composed of frequency-specific coefficients, and the high-frequency feature extraction module 211 may obtain the DCT coefficient 402 from which the components corresponding to the low frequencies are removed by changing components of which indices are smaller than a certain number (τ) to 0 (e.g., through a sparse matrix operation).

In an embodiment, the first convolutional neural network 212 may extract, from a high-frequency feature, a first feature (ck) 82, associated with a feature value calculated based on a B-spline basis. For example, a pixel value may be the intensity or an RGB value of a corresponding pixel. In this case, when the first warping module 200 includes one or more B-spline warping modules 210, k is an index indicating which B-spline warping module is used from among the one or more B-spline warping modules 210.

In an embodiment, the second convolutional neural network 213 may extract, from the high-frequency feature, a second feature (6k) 83 associated with a slope of the B-spline basis.

In an embodiment, the third convolutional neural network 214 may extract, from the high-frequency feature, a third feature (Kk) 84 associated with the B-spline basis and a bias.

In an embodiment, the B-spline representation module 215 may transform the high-frequency feature 81 into a B-spline representation using a first feature 82, a second feature 83, and a third feature 84. In this regard, the B-spline representation may be understood as calculating a feature value corresponding to a target pixel by using the B-spline basis, and the B-spline basis is a curve that represents the degree to which other surrounding pixels of the target pixel influence a pixel value of the target pixel. Hereinafter, the degree to which other surrounding pixels of the target pixel influence the pixel value of the target pixel is referred to as a basis weight.

As shown in FIG. 3, the B-spline representation module 215 may generate a B-spline basis by performing elementwise subtraction of the third feature 84 from relative coordinate information (Δx) 85 of the target pixel and elementwise multiplication with the second feature 83. In this regard, the relative coordinate information (Δx) 85 of the target pixel may be understood as a position of the target pixel. Moreover, the B-spline representation module 215 may calculate a basis weight corresponding to the target pixel based on the B-spline basis by using the basis weight calculation module 216, and may generate a B-spline representation by performing elementwise multiplication between the first feature 82 and the basis weight. The generation of the B-spline representation is described in detail with reference to FIG. 5.

FIG. 5 illustrates, as an example, a case where the image processing system 1 generates a second image 520 by performing image warping on a first image 510. To determine a pixel value of a target pixel of the second image 520, the image processing system 1 may take into account the degree to which corresponding surrounding pixels of the first image 510 influence the pixel value of the target pixel. For example, as shown in FIG. 5, when the pixel value of the target pixel of the second image 520 is determined by taking into account four pixels c₀, c₁, c₂, and c₃ of the first image 510, the image processing system 1 may calculate the degree to which the four pixels c₀, c₁, c₂, and c₃ influence the pixel value of the target pixel. In this case, the degree to which the four pixels c₀, c₁, c₂, and c₃ influence the pixel value of the target pixel may be calculated based on B-spline bases b⁰, b¹, b², and b³.

A graph 530 illustrates B-spline bases b⁰, b¹, b², and b³ corresponding to four pixels p₀, p₁, p₂, and p₃. In the graph 530, a horizontal axis represents indices of pixels, and a vertical axis represents basis weights. Referring to the graph 530, when relative coordinate information about the target pixel is Δx, the degree to which the four pixels p₀, p₁, p₂, and p₃ influence the pixel value of the target pixel (i.e., basis weights of the B-spline bases b⁰, b¹, b², and b³ at Δx) may be determined. In the graph 530, it may be understood that the pixel p₁ has the greatest influence on the pixel value of the target pixel, followed by the pixel p₂, the pixel p₀, and the pixel p₃ in order of influence on the pixel value of the target pixel. In this case, as shown in Equation 1, the pixel value of the target pixel may be calculated by multiplying each of basis weights b⁰(Δx), b¹(Δx), b²(Δx), and b³(Δx) by pixel values c₀, c₁, c₂, and c₃ of the pixels p₀, p₁, p₂, and p₃, respectively, and then adding the results (i.e., by performing a weighted sum operation).

$${\sum }_{{i - 0}^{}}^{3} {c}_{i} \cdot ( {b}^{i} ( Δ x ) ) \qquad [ Equation 1 ]$$

However, because the B-spline bases b⁰, b¹, b², and b³ illustrated in the graph 530 are uniquely determined, when the pixel value of the target pixel is calculated by directly using the B-spline bases, a distorted pixel value may be calculated for pixels in a high-frequency region where the difference in pixel value between surrounding pixels is large, resulting in artifacts, such as blur, jagging, and moire.

Therefore, the image processing system 1 according to an embodiment of the present disclosure may secure robust performance against artifacts during image warping by training the B-spline bases b⁰, b¹, b², and b³ to vary according to frequency by using the architecture of FIGS. 1 and 3. That is, the image processing system 1 according to an embodiment of the present disclosure may generate different B-spline bases according to frequency by using the second feature 83 and the third feature 84 extracted by using the B-spline warping module 210.

As a result, as shown in FIG. 5, the basis weight calculation module 216 according to an embodiment may calculate a basis weight corresponding to the target pixel by using different B-spline bases according to frequency. For example, basis weights corresponding to pixels in the high-frequency region 521 may be calculated by using B-spline bases that are relatively narrow in width and positioned close to each other, and basis weights corresponding to pixels in the low-frequency region 522 may be calculated by using B-spline bases that are relatively wide in width and positioned far from each other. Consequently, the calculation of a feature value (i.e., a B-spline representation) corresponding to the target pixel by the B-spline representation module 215 may be expressed as shown in Equation 2.

$${\sum }_{i - 0}^{3} {c}_{i} \cdot ( {b}^{i} ( ( Δ x - {κ}_{i} ) \cdot δ ) ) \qquad [ Equation 2 ]$$

Referring again to FIG. 3, in an embodiment, the B-spline warping module 210A may process the image feature 21 and the downscaled coordinate information 31 by using the bilinear warping module 218. In this regard, the bilinear warping module 218 may process the image feature 21 via bilinear interpolation, and may process the image feature 21 and the downscaled coordinate information 31, for example, by performing a weighted average operation using a distance between the target pixel and another surrounding pixel of the target pixel and a pixel value (e.g., intensity) of the other pixel.

In an embodiment, the B-spline warping module 210A may process a B-spline representation by using the MLP network 217, and may generate the first warped feature 41 by performing elementwise addition of an output of the MLP network 217 and an output of the bilinear warping module. In this regard, the MLP network 217 may include a convolutional layer and an activation function.

The operation of the B-spline warping module 210A described above may be similarly performed by the other B-spline warping modules 210B, 210C, and 210D and the second warping module 400. For example, the B-spline warping module 210B may perform the aforementioned operations by using the second image feature 22 and the downscaled coordinate information 32, the B-spline warping module 210C may perform the aforementioned operations by using the third image feature 23 and the downscaled coordinate information 33, the B-spline warping module 210D may perform the aforementioned operations by using the fourth image feature 24 and the downscaled coordinate information 34, and the second warping module 400 may perform the aforementioned operations by using the input image 10 and the coordinate information 30.

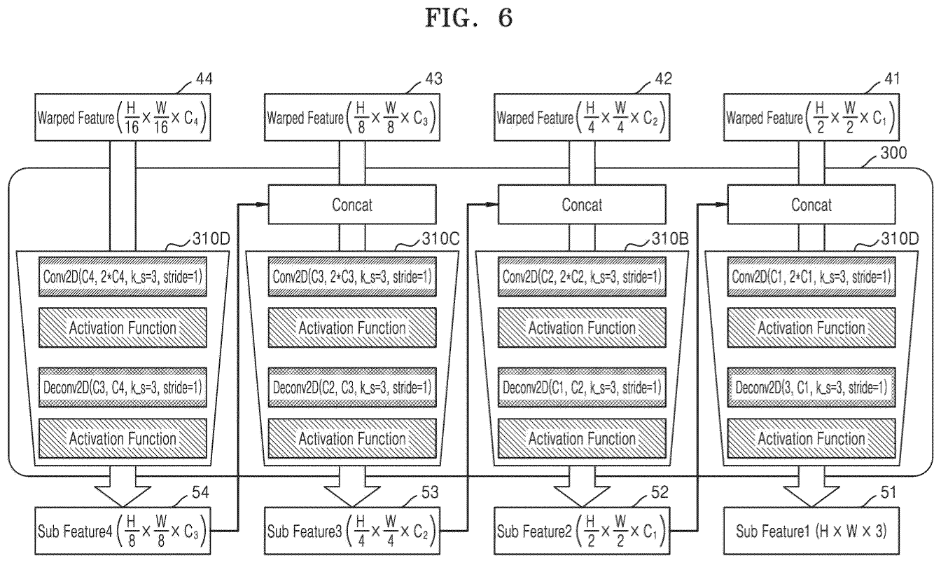

FIG. 6 is a diagram illustrating the structure and operation of the image reconstruction module 300 according to an embodiment of the present disclosure. The image reconstruction module 300 illustrated in FIG. 6 corresponds to a case where the image feature extraction module 100 extracts image features in four levels, but the number of levels (i.e., hierarchies) is not limited thereto as described above.

In an embodiment, the image reconstruction module 300 may hierarchically generate the sub-feature 50. In this case, the image reconstruction module 300 may include the plurality of decoders 310. Each of the decoders may generate a low-level sub-feature by concatenating a sub-feature, decoded by a high-level decoder, with a warped feature of a current level and decoding the concatenated features.

The fourth decoder 310D may generate the fourth sub-feature 54 by decoding the first warped feature 44. In this case, the fourth decoder 310D may generate the fourth sub-feature 54 having a set number (C₃) of channels by increasing the height and width of the first warped feature 44 by two times. For example, when the first warped feature 44 is represented as a vector of (H/16×W/16×C₄) dimensions, the fourth sub-feature 54 may be represented as a vector of (H/8×W/8×C₃) dimensions.

The third decoder 310C may generate the third sub-feature 53 by concatenating the fourth sub-feature 54 with the first warped feature 43 and decoding the concatenated features. In this case, the third decoder 310C may generate the third sub-feature 53 having a set number (C₂) of channels by increasing the height and width of the first warped feature 43 by two times. For example, when the first warped feature 43 is represented as a vector of (H/8×W/8×C₃) dimensions, the third sub-feature 53 may be represented as a vector of (H/4×W/4×C₂) dimensions.

The second decoder 310B may generate a second sub-feature 52 by concatenating the third sub-feature 53 with the first warped feature 42 and decoding the concatenated features. In this case, the second decoder 310B may generate the second sub-feature 52 having a set number (C₁) of channels by increasing the height and width of the first warped feature 42 by two times. For example, when the first warped feature 42 is represented as a vector of (H/4×W/4×C₂) dimensions, the second sub-feature 52 may be represented as a vector of (H/2×W/2×C₁) dimensions.

The first decoder 310A may generate the first sub-feature 51 by concatenating the second sub-feature 52 with the first warped feature 41 and decoding the concatenated features. In this case, the first decoder 310A may generate the first sub-feature 51 having three channels (i.e., the same number of channels as the input image 10) by increasing the height and width of the first warped feature 41 by two times. For example, when the first warped feature 41 is represented as a vector of (H/2×W/2×C₁) dimensions, the first sub-feature 51 may be represented as a vector of (H×W×3) dimensions.

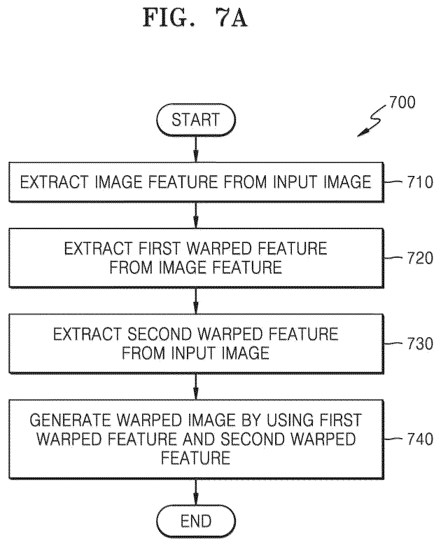

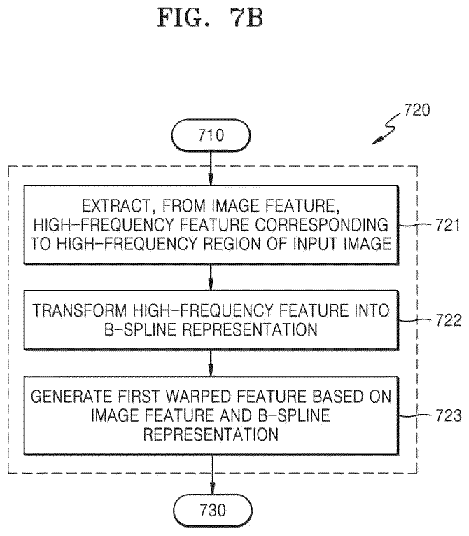

FIGS. 7A and 7B are flowcharts of a method 700 of processing an image, according to an embodiment of the present disclosure. The method 700 may be performed by an electronic apparatus 800 including the image processing system 1.

In operation 710, an image feature 20 may be extracted from an input image 10. In an embodiment, in operation 710, the image feature 20 may be extracted in a plurality of levels.

In operation 720, a first warped feature 40 may be extracted from the image feature 20. In detail, in operation 721, a high-frequency feature 81 corresponding to a high-frequency region of the input image 10 may be extracted from the image feature 20. In operation 722, the high-frequency feature 81 may be transformed into a B-spline representation. In operation 723, the first warped feature 40 may be generated based on the image feature 20 and the B-spline representation.

In an embodiment, in operation 721, a DCT coefficient may be extracted by performing a DCT on the image feature 20, components corresponding to low frequencies may be removed from the DCT coefficient, and the high-frequency feature 81 may be generated by performing an inverse DCT on the DCT coefficient from which the components corresponding to the low frequencies are removed.

In an embodiment, in operation 722, a first feature 82 associated with a feature value calculated based on a B-spline basis may be extracted from the high-frequency feature 81 by using a first convolutional neural network 212, a second feature 83 associated with a slope of the B-spline basis may be extracted from the high-frequency feature by using a second convolutional neural network 213, a third feature 84 associated with a bias of the B-spline basis may be extracted from the high-frequency feature by using a third convolutional neural network 214, and a B-spline representation may be generated based on the first feature 82, the second feature 83, and the third feature 84.

In an embodiment, in operation 722, one or more B-spline bases may be generated based on the second feature 83, the third feature 84, and relative coordinate information 85 representing a position of a target pixel, a basis weight corresponding to the target pixel may be calculated based on the one or more B-spline bases, and a B-spline representation may be generated by performing a weighted sum operation between the first feature 82 and the basis weight.

In an embodiment, in operation 720, the image feature 20 and downscaled coordinate information 31, 32, 33, and 34 may be processed by using a bilinear warping module 218, the B-spline representation may be processed by using an MLP network 217, and the first warped feature 40 may be generated by performing elementwise addition of an output of the MLP network 217 and an output of the bilinear warping module 218.

In operation 730, a second warped feature 60 may be extracted from the input image 10 by using coordinate information 30.

In operation 740, a warped image 70 may be generated by using the first warped feature 40 and the second warped feature 60.

In an embodiment, in operation 740, a sub-feature 50 configured to reconstruct the warped image 70 may be generated by decoding the first warped feature 40, the sub-feature 50 may be concatenated with the second warped feature 60, and the warped image 70 may be generated by using a convolutional neural network 500.

In an embodiment, the method 700 may further include receiving, from a user, a user input for determining coordinate information 30.

In an embodiment, the method 700 may further include detecting a distance between a screen onto which the warped image 70 is to be projected and the electronic apparatus 800 and a shape of the screen onto which the warped image is to be projected, and determining the coordinate information 30 based on the detected distance and shape.

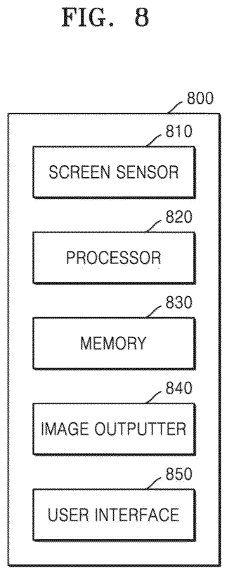

FIG. 8 is a block diagram of the electronic apparatus 800 according to an embodiment of the present disclosure.

The electronic apparatus 800 illustrated in FIG. 8 may process an input image by performing the aforementioned operations of the image processing system 1. In an embodiment, the electronic apparatus 800 may include one or more of a screen sensor 810, at least one processor 820, memory 830, an image outputter 840, and a user interface 850. However, the components of the electronic apparatus 800 are not limited thereto, and may include more components than those illustrated in FIG. 8, or may not include one or more of the components illustrated in FIG. 8. As an example, the electronic apparatus 800 may include a mobile apparatus (e.g., a smartphone, a smartwatch, a tablet personal computer (PC), or the like) further including a communication interface. As another example, the electronic apparatus 800 may include a server not including the screen sensor 810 and the image outputter 840. In an embodiment, some or all of the screen sensor 810, the processor 820, the memory 830, the image outputter 840, and the user interface 850 may be implemented in a form of a single chip, and the processor 820 may include one or more processors.

In an embodiment, the screen sensor 810 may detect a distance between a screen onto which a warped image is to be projected and the electronic apparatus 800. For example, the screen sensor 810 may include a distance sensor, such as an infrared sensor, a radar sensor, a light detection and ranging (LiDAR) sensor, or a time of flight (ToF) sensor. The screen sensor 810 may output, to the processor 820, a result of detecting the distance between the screen and the electronic apparatus 800, and the processor 820 may adjust a focus of the warped image to be projected onto the screen based on the distance between the screen and the electronic apparatus 800.

In an embodiment, the screen sensor 810 may detect a shape of the screen onto which the warped image is to be projected. For example, the screen sensor 810 may detect whether the screen has a flat surface, an angled surface, or a curved surface, and may output a result of the detection to the processor 820. The processor 820 may determine the coordinate information 30 based on the result of the detection.

In an embodiment, the processor 820 is a component configured to control a series of processes for the electronic apparatus 800 to operate and may include one or more processors. The one or more processors included in the processor 820 may include circuitry, such as a SoC or an IC. The one or more processors included in the processor 820 may include a general-purpose processor such as a CPU, an AP, or a DSP, a graphics-dedicated processor such as a GPU or a VPU, or an artificial intelligence-dedicated processor such as an NPU. For example, when the one or more processors include an artificial intelligence-dedicated processor, the artificial intelligence-dedicated processor may be designed with a hardware structure specialized for processing a specific artificial intelligence model.

In an embodiment, the processor 820 may write data to the memory 830 or read data stored in the memory 830, and may particularly process data according to predefined operation rules or artificial intelligence models by executing a program or at least one instruction stored in the memory 830. Accordingly, the processor 820 may perform the aforementioned operations of the image processing system 1.

In an embodiment, the memory 830 is a component configured to store various programs or data and may include a storage medium or a combination of storage media, such as ROM, random access memory (RAM), a hard disk, a CD-ROM, or a digital versatile disc (DVD). The memory 830 may not be provided separately and may be configured to be included in the processor 820. The memory 830 may be configured as a volatile memory, a nonvolatile memory, or a combination of a volatile memory and a nonvolatile memory. The memory 830 may store a program for performing the aforementioned operations of the image processing system 1. The memory 830 may also provide data stored therein to the processor 820 upon request by the processor 820.

In an embodiment, the image outputter 840 is a component configured to output the warped image 70. As an example, the image outputter 840 may include a display that displays the warped image 70. In this case, the electronic apparatus 800 may be implemented in a form of a television (TV), a smartphone, a tablet PC, or the like, including a display. As another example, the image outputter 840 may include a light source (e.g., a high intensity discharge (HID) lamp, an ultra-high performance (UHP) lamp, a light emitting diode (LED) lamp, a laser, or a xenon lamp) configured to project the warped image 70 onto the screen. In this case, the electronic apparatus 800 may be implemented in a form of a projector.

In an embodiment, the user interface 850 is a component configured to receive control commands or information from a user. As an example, the user interface 850 may include a touch screen, a hard button, or a microphone. In an embodiment, the user interface 850 may receive, from the user, a user input for determining the coordinate information.

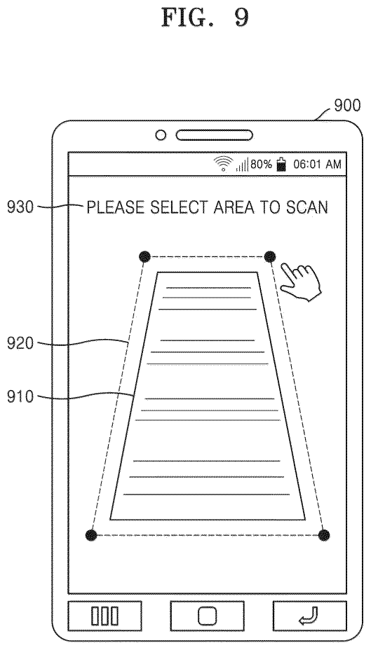

FIG. 9 illustrates an example in which an image processing system is applied to a mobile apparatus, according to an embodiment of the present disclosure.

FIG. 9 illustrates an example in which the image processing system 1 according to an embodiment of the present disclosure is applied to a mobile apparatus 900 as a document scanning application. In this regard, the mobile apparatus 900 may correspond to the electronic apparatus 800.

In FIG. 9, the mobile apparatus 900 may reconstruct, into a rectangular image, an image 910 having a parallelogram shape due to being captured obliquely. In this case, the mobile apparatus 900 may output a notification message 930 stating “Please select an area to scan” through a display to receive coordinate information from a user, and may output an interface 920 to allow the user to select an area to scan. When the user adjusts the interface 920 (e.g., through a touch input) to match the shape of the image 910, the mobile apparatus 900 may determine coordinate information by using the input area to scan, and may reconstruct the image 910 having a rectangular shape into a square-shaped image. That is, the mobile apparatus 900 may perform image warping on the input image 910 by operating the image processing system 1.

While FIG. 9 illustrates a situation where a document is captured obliquely as an example, the image processing system 1 according to an embodiment of the present disclosure may also be applied to images other than documents, such as drawings or photographs.

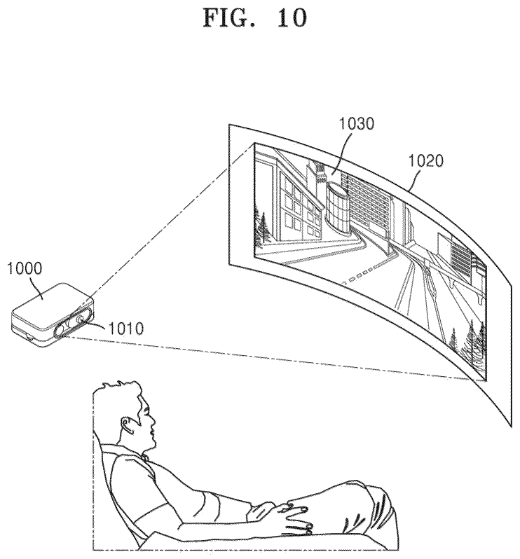

FIG. 10 illustrates an example in which the image processing system 1 is applied to a projector 1000, according to an embodiment of the present disclosure.

FIG. 10 illustrates a case where the image processing system 1 according to an embodiment of the present disclosure is applied to the projector 1000 to project an image 1030 onto a curved surface 1020. In this regard, the projector 1000 may correspond to the electronic apparatus 800.

In FIG. 10, when the projector 1000 directly projects an original image onto the curved surface 1020, the image may appear distorted to a user according to the curved surface 1020, causing objects in the image to appear abnormal. To allow the projected image to appear in an undistorted form to the user, the projector 1000 may reconstruct the original image by taking into account the curved surface 1020. In this case, the projector 1000 may include a sensor 1010 configured to detect the curved surface 1020, and may measure a distance from the projector 1000 to the curved surface 1020, a curvature of the curved surface 1020, or the like by using the sensor 1010. The projector 1000 may determine coordinate information based on information about the detected curved surface 1020, and may reconstruct the original image into a form suitable for projection onto the curved surface by operating the image processing system 1. In this regard, the sensor 1010 may correspond to the screen sensor 810.

A method of processing an image, according to an embodiment of the present disclosure, may include extracting an image feature from an input image.

In an embodiment, the method may include extracting a first warped feature from the image feature.

In an embodiment, the method may include extracting, by using coordinate information, a second warped feature from the input image.

In an embodiment, the method may include generating a warped image by using the first warped feature and the second warped feature.

In an embodiment, the extracting of the first warped feature from the image feature may include extracting, from the image feature, a high-frequency feature corresponding to a high-frequency region of the input image.

In an embodiment, the extracting of the first warped feature from the image feature may include transforming the high-frequency feature into a B-spline representation.

In an embodiment, the extracting of the first warped feature from the image feature may include generating the first warped feature based on the image feature and the B-spline representation.

In an embodiment, the extracting of the image feature from the input image may include extracting the image feature in a plurality of levels.

In an embodiment, the extracting of the high-frequency feature corresponding to the high-frequency region of the input image from the image feature may include extracting a discrete cosine transform (DCT) coefficient by performing a DCT on the image feature, removing, from the DCT coefficient, components corresponding to low frequencies, and generating the high-frequency feature by performing an inverse DCT on the DCT coefficient from which the components corresponding to the low frequencies are removed.

In an embodiment, the transforming of the high-frequency feature into the B-spline representation may include, by using a first convolutional neural network, extracting, from the high-frequency feature, a first feature associated with a feature value calculated based on a B-spline basis, by using a second convolutional neural network, extracting, from the high-frequency feature, a second feature associated with a slope of the B-spline basis, by using a third convolutional neural network, extracting, from the high-frequency feature, a third feature associated with a bias of the B-spline basis, and generating a B-spline representation based on the first feature, the second feature, and the third feature.

In an embodiment, the generating of the B-spline representation based on the first feature, the second feature, and the third feature may include generating one or more B-spline bases based on the second feature, the third feature, and relative coordinate information representing a position of a target pixel, based on the one or more B-spline bases, calculating a basis weight corresponding to the target pixel, and generating the B-spline representation by performing a weighted sum operation between the first feature and the basis weight.

In an embodiment, the generating of the first warped feature based on the image feature and the B-spline representation may include processing the image feature and downscaled coordinate information by using a bilinear warping module, processing the B-spline representation by using a multilayer perceptron (MLP) network, and generating the first warped feature by performing elementwise addition of an output of the MLP network and an output of the bilinear warping module.

In an embodiment, the generating of the warped image by using the first warped feature and the second warped feature may include, by decoding the first warped feature, generating a sub-feature configured to reconstruct the warped image, and concatenating the sub-feature with the second warped feature and generating the warped image by using a convolutional neural network.

In an embodiment, the method may further include receiving, from a user, a user input for determining the coordinate information.

In an embodiment, the method may further include detecting a distance between a screen onto which the warped image is to be projected and an image processing apparatus and a shape of the screen onto which the warped image is to be projected, and determining the coordinate information based on the detected distance and shape.

An electronic apparatus 800 for processing an image, according to an embodiment of the present disclosure, may include memory 830 storing a program for processing the image, and at least one processor 820. In an embodiment, the program may be configured to, when executed by the at least one processor 820, may cause the electronic apparatus 800 to perform operations including extracting an image feature from an input image.

In an embodiment, the operations may include extracting a first warped feature from the image feature.

In an embodiment, the operations may include extracting, by using coordinate information, a second warped feature from the input image.

In an embodiment, the operations may include generate a warped image by using the first warped feature and the second warped feature.

In an embodiment, the extracting of the first warped feature from the image feature may include extracting, from the image feature, a high-frequency feature corresponding to a high-frequency region of the input image.

In an embodiment, the extracting of the first warped feature from the image feature may include transforming the high-frequency feature into a B-spline representation.

In an embodiment, the extracting of the first warped feature from the image feature may include generating the first warped feature based on the image feature and the B-spline representation.

In an embodiment, the extracting of the image feature from the input image may include extracting the image feature in a plurality of levels.

In an embodiment, the extracting of the high-frequency feature corresponding to the high-frequency region of the input image from the image feature may include extracting a discrete cosine transform (DCT) coefficient by performing a DCT on the image feature, removing, from the DCT coefficient, components corresponding to low frequencies, and generating the high-frequency feature by performing an inverse DCT on the DCT coefficient from which the components corresponding to the low frequencies are removed.

In an embodiment, the transforming of the high-frequency feature into the B-spline representation may include, by using a first convolutional neural network, extracting, from the high-frequency feature, a first feature associated with a feature value calculated based on a B-spline basis, by using a second convolutional neural network, extracting, from the high-frequency feature, a second feature associated with a slope of the B-spline basis, by using a third convolutional neural network, extracting, from the high-frequency feature, a third feature associated with a bias of the B-spline basis, and generating a B-spline representation based on the first feature, the second feature, and the third feature.

In an embodiment, the generating of the B-spline representation based on the first feature, the second feature, and the third feature may include generating one or more B-spline bases based on the second feature, the third feature, and relative coordinate information representing a position of a target pixel, based on the one or more B-spline bases, calculating a basis weight corresponding to the target pixel, and generating the B-spline representation by performing a weighted sum operation between the first feature and the basis weight.

In an embodiment, the generating of the first warped feature based on the image feature and the B-spline representation may include processing the image feature and downscaled coordinate information by using a bilinear warping module, processing the B-spline representation by using a multilayer perceptron (MLP) network, and generating the first warped feature by performing elementwise addition of an output of the MLP network and an output of the bilinear warping module.

In an embodiment, the generating of the warped image by using the first warped feature and the second warped feature may include, by decoding the first warped feature, generating a sub-feature configured to reconstruct the warped image, and concatenating the sub-feature with the second warped feature and generating the warped image by using a convolutional neural network.

In an embodiment, the electronic apparatus 800 may further include a user interface 850 configured to receive, from a user, a user input for determining the coordinate information.

In an embodiment, the electronic apparatus 800 may further include a screen sensor 810 configured to detect a distance between a screen onto which the warped image is to be projected and an image processing apparatus and a shape of the screen onto which the warped image is to be projected, and the operations may further include determining the coordinate information based on the detected distance and shape.

What is claimed is:

1. A method of processing an image, the method comprising:
obtaining an image feature from an input image;
obtaining a first warped feature from the image feature;
obtaining, by using coordinate information, a second warped feature from the input image; and
generating a warped image by using the first warped feature and the second warped feature,
wherein the obtaining the first warped feature from the image feature comprises:
obtaining, from the image feature, a high-frequency feature corresponding to a high-frequency region of the input image;
transforming the high-frequency feature into a B-spline representation; and
generating the first warped feature based on the image feature and the B-spline representation.

2. The method of claim 1, wherein the obtaining the image feature from the input image comprises obtaining the image feature at a plurality of levels.

3. The method of claim 1, wherein the obtaining the high-frequency feature corresponding to the high-frequency region of the input image from the image feature comprises:
obtaining a discrete cosine transform (DCT) coefficient by performing a DCT on the image feature;
removing, from the DCT coefficient, components corresponding to low frequencies; and
generating the high-frequency feature by performing an inverse DCT on the DCT coefficient from which the components corresponding to the low frequencies are removed.

4. The method of claim 1, wherein the transforming the high-frequency feature into the B-spline representation comprises:
obtaining from the high-frequency feature, by using a first convolutional neural network, a first feature associated with a feature value identified based on a B-spline basis;
obtaining from the high-frequency feature, by using a second convolutional neural network, a second feature associated with a slope of the B-spline basis;
obtaining from the high-frequency feature, by using a third convolutional neural network, a third feature associated with a bias of the B-spline basis; and
generating the B-spline representation based on the first feature, the second feature, and the third feature.

5. The method of claim 4, wherein the generating the B-spline representation based on the first feature, the second feature, and the third feature comprises:
generating one or more B-spline bases based on the second feature, the third feature, and relative coordinate information representing a position of a target pixel;
based on the one or more B-spline bases, identifying a basis weight corresponding to the target pixel; and
generating the B-spline representation by performing a weighted sum operation between the first feature and the basis weight.

6. The method of claim 1, wherein the generating the first warped feature based on the image feature and the B-spline representation comprises:
processing the image feature and downscaled coordinate information by using a bilinear warping module;
processing the B-spline representation by using a multilayer perceptron (MLP) network; and
generating the first warped feature by performing elementwise addition of an output of the MLP network and an output of the bilinear warping module.

7. The method of claim 1, wherein the generating the warped image by using the first warped feature and the second warped feature comprises:
generating, by decoding the first warped feature, a sub-feature configured to reconstruct the warped image; and
concatenating the sub-feature with the second warped feature and generating the warped image by using a convolutional neural network.

8. The method of claim 1, further comprising receiving a user input for determining the coordinate information.

9. The method of claim 1, further comprising:
detecting a distance between a screen onto which the warped image is to be projected and an image processing apparatus and a shape of the screen onto which the warped image is to be projected; and
determining the coordinate information based on the detected distance and the detected shape.

10. A non-transitory computer-readable recording medium having stored thereon instructions that are executed by at least one processor individually or collectively to perform a method comprising:
obtaining an image feature from an input image;
obtaining a first warped feature from the image feature;
obtaining, by using coordinate information, a second warped feature from the input image; and
generating a warped image by using the first warped feature and the second warped feature,
wherein the obtaining the first warped feature from the image feature comprises:
obtaining, from the image feature, a high-frequency feature corresponding to a high-frequency region of the input image;
transforming the high-frequency feature into a B-spline representation; and
generating the first warped feature based on the image feature and the B-spline representation.

11. An electronic apparatus for processing an image, the electronic apparatus comprising:
memory storing instructions for processing the image; and
at least one processor,
wherein the instructions, when executed by the at least one processor individually or collectively, cause the electronic apparatus to:
obtain an image feature from an input image;
obtain a first warped feature from the image feature;
obtain, by using coordinate information, a second warped feature from the input image; and
generate a warped image by using the first warped feature and the second warped feature,
wherein the instructions, when executed by the at least one processor individually or collectively, cause the electronic apparatus to obtain the first warped feature from the image feature by:
obtaining, from the image feature, a high-frequency feature corresponding to a high-frequency region of the input image;
transforming the high-frequency feature into a B-spline representation; and
generating the first warped feature based on the image feature and the B-spline representation.

12. The electronic apparatus of claim 11, wherein the instructions, when executed by the at least one processor individually or collectively, cause the electronic apparatus to transform the transforming the high-frequency feature into the B-spline representation by
obtaining from the high-frequency feature, by using a first convolutional neural network, a first feature associated with a feature value identified based on a B-spline basis;
obtaining from the high-frequency feature, by using a second convolutional neural network, a second feature associated with a slope of the B-spline basis;
obtaining from the high-frequency feature, by using a third convolutional neural network, a third feature associated with a bias of the B-spline basis; and
generating the B-spline representation based on the first feature, the second feature, and the third feature.

13. The electronic apparatus of claim 12, wherein the instructions, when executed by the at least one processor individually or collectively, cause the electronic apparatus to generate the B-spline representation based on the first feature, the second feature, and the third feature by:
generating one or more B-spline bases based on the second feature, the third feature, and relative coordinate information representing a position of a target pixel;
based on the one or more B-spline bases, identifying a basis weight corresponding to the target pixel; and
generating the B-spline representation by performing a weighted sum operation between the first feature and the basis weight.

14. The electronic apparatus of claim 11, wherein the instructions, when executed by the at least one processor individually or collectively, cause the electronic apparatus to generate the first warped feature based on the image feature and the B-spline representation by:
processing the image feature and downscaled coordinate information by using a bilinear warping module;
processing the B-spline representation by using a multilayer perceptron (MLP) network; and
generating the first warped feature by performing elementwise addition of an output of the MLP network and an output of the bilinear warping module.

15. The electronic apparatus of claim 11, wherein the instructions, when executed by the at least one processor individually or collectively, cause the electronic apparatus to generate the warped image by using the first warped feature and the second warped feature by:
generating, by decoding the first warped feature, a sub-feature configured to reconstruct the warped image; and
concatenating the sub-feature with the second warped feature and generating the warped image by using a convolutional neural network.
